(19) United States
(12) Patent Application Publication
(10) Pub. No.: US 2023/0175383 A1
(43) Pub. Date: Jun. 8, 2023

(54) SYSTEM AND METHOD FOR AUTOMATED IDENTIFICATION OF MUD MOTOR DRILLING MODE

(71) Applicant: Halliburton Energy Services, Inc., Houston, TX (US)

(72) Inventors: Vy Pho, Houston, TX (US); Julien Christian Marck, Houston, TX (US); Umut Zalluhoglu, Houston, TX (US)

(21) Appl. No.: 17/544,325

(22) Filed: Dec. 7, 2021

(51) Int. Cl. E21B 44/06; G06N 20/20; E21B 45/00

(52) U.S. Cl. CPC E21B 44/06; E21B 45/00; G06N 20/20; E21B 2200/20; E21B 2200/22

(57) ABSTRACT

The disclosure provides for a method for identifying a mud motor drilling mode. The method comprises accessing historical run information stored in a memory of a controller and determining drilling measurements based on the historical run information. The method further comprises training at least one initial model with a machine learning method using the determined drilling measurements, wherein the at least one initial model comprises one or more inputs selected from a group consisting of revolutions per minute, tool-face, torque, flowrate, weight on bit, rate of penetration, differential pressure, a derivative thereof, and any combination thereof. The method further comprises utilizing the trained at least one initial model to determine the mud motor drilling mode for a mud motor.

### TECHNICAL FIELD OF THE INVENTION

The present disclosure relates generally to wellsite operations and, more particularly, to systems and methods for automated identification of mud motor drilling modes.

### BACKGROUND

To control a directional well and estimate the current and future trajectories of the borehole, accurate knowledge about the drilling-system steering behavior is needed, which maps system inputs to output responses. During a mud-motor operation, there is no direct information about the tool steering input, sometimes referred to as drilling mode. Traditionally, the drilling mode is communicated by the directional driller, then executed by the driller. The directional driller checks visually the quality of the tool-face control while sliding. However, there is no systematic tool commonly available to automatically detect the drilling mode.

### BRIEF DESCRIPTION OF THE DRAWINGS

FIG. 1 is a schematic diagram of a drilling system at a well site, according to one or more aspects of the present disclosure.

FIG. 2 is a diagram illustrating an example controller, according to aspects of the present disclosure.

FIG. 3 is a flowchart illustrating an example method of operation, according to aspects of the present disclosure.

FIG. 4 is a diagram illustrating an example model, according to aspects of the present disclosure.

FIG. 5A is a graph illustrating RPM against depth, according to aspects of the present disclosure.

FIG. 5B is a graph illustrating mud motor drilling mode against depth, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present invention are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time consuming but would nevertheless be a routine undertaking for those of ordinary skill in the art having the benefit of the present disclosure.

Throughout this disclosure, a reference numeral followed by an alphabetical character refers to a specific instance of an element and the reference numeral alone refers to the element generically or collectively. Thus, as an example (not shown in the drawings), widget “la” refers to an instance of a widget class, which may be referred to collectively as widgets “1” and any one of which may be referred to generically as a widget “1”. In the figures and the description, like numerals are intended to represent like elements.

To facilitate a better understanding of the present disclosure, the following examples of certain embodiments are given. In no way should the following examples be read to limit, or define, the scope of the disclosure. Embodiments described below with respect to one implementation are not intended to be limiting.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. The information handling system may also include one or more interface units capable of transmitting one or more signals to a controller, actuator, or like device.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

The terms “couple” or “couples,” as used herein, are intended to mean either an indirect or direct connection. Thus, if a first device couples to a second device, that connection may be through a direct connection, or through an indirect electrical connection or a shaft coupling via other devices and connections.

The present disclosure provides for systems and methods for identification of mud motor drilling modes. In embodiments, there may be two types of drilling mode for mud motors: rotating and sliding. In the rotating mode, a rotary table or top-drive rotates the entire drill-string and causes the bend in the motor to point equally in all directions. In theory, the tool would hold its current attitude (inclination and azimuth angles) but is still subject to some trends related to gravity or the anisotropy of the rock formation. In the sliding mode, the lower part of the drill-string should not be rotating, the motor rotates the bit, and the hole is drilled in the direction the bit (and the bend in the motor) is pointing to. Based on this working principle of the mud motor, a rule-based method is often used to determine the drilling mode. For example, when surface revolutions per minute (RPM) is bigger than 35 RPM, the drilling mode is rotating. When RPM is close to 0, indicating the drill-string is not rotating, the drilling mode is sliding. Sometimes in sliding mode, due to the friction between the drilling and the wellbore, the axial weight cannot transfer efficiently to the bit and reduces the rate of penetration. The directional driller may then apply some rotation back and forth to the top of the drill-string to break the friction and have better weight transfer. This action is called pipe rocking. In addition, the rotating RPM, as well as pipe rocking RPM, could change from between operational runs, so manual monitoring and adjustments have been needed to correctly detect the drilling mode. Data quality may affect the performance of this rule-based detection method as well. The present disclosure provides for a system to (i) clean and prepare data (ii) train model(s) by learning from historical data, (iii) deploy the model(s) to automatically detect drilling mode in real time, and (iv) update the model(s) as new data is available.

The present disclosure provides for a methodology to create one or more models that can be used to detect the drilling mode based on historical data. An algorithm processes and extracts statistical information from one or more surface and/or downhole operating parameters, as well as the actual drilling mode of the historical data, and uses those as the inputs to the learning algorithm. Next, the model(s) is developed such that certain performance criteria are met. Then, the model(s) may be used to detect the drilling mode in real-time given the available data on the current operational run.

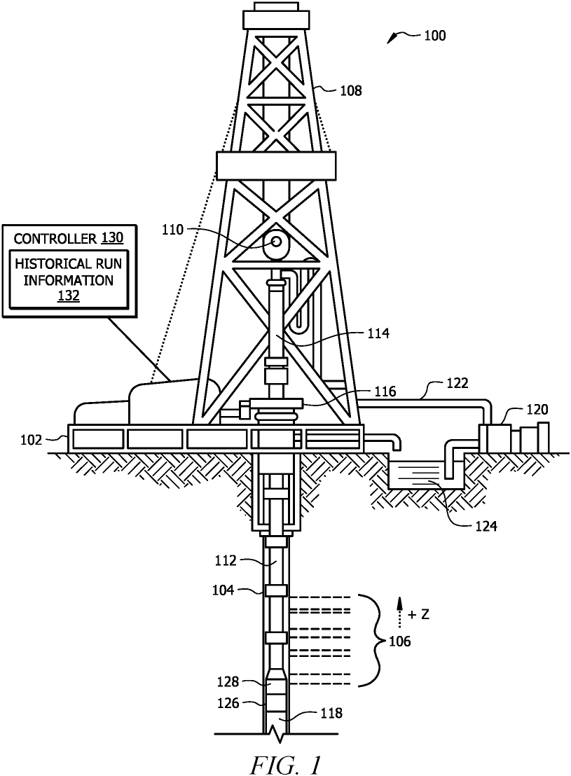

FIG. 1 is a schematic diagram of an exemplary drilling system 100 that may employ the principles of the present disclosure, according to one or more embodiments. As illustrated, the drilling system 100 may include a drilling platform 102 positioned at the surface and a wellbore 104 that extends from the drilling platform 102 into one or more subterranean formations 106. In other embodiments, such as in an offshore drilling operation, a volume of water may separate the drilling platform 102 and the wellbore 104. Even though FIG. 1 depicts a land-based drilling platform 102, it will be appreciated that the embodiments of the present disclosure are equally well suited for use in other types of drilling platforms, such as offshore platforms, or rigs used in any other geographical locations. The present disclosure contemplates that wellbore 104 may be vertical, horizontal or at any deviation.

The drilling system 100 may include a derrick 108 supported by the drilling platform 102 and having a traveling block 110 for raising and lowering a conveyance 112, such as a drill string. A kelly 114 may support the conveyance 112 as it is lowered through a rotary table 116. A drill bit 118 may be coupled to the conveyance 112 and driven by a downhole motor and/or by rotation of the conveyance 112 by the rotary table 116. As the drill bit 118 rotates, it creates the wellbore 104, which penetrates the subterranean formations 106. A pump 120 may circulate drilling fluid through a feed pipe 122 and the kelly 114, downhole through the interior of conveyance 112, through orifices in the drill bit 118, back to the surface via the annulus defined around conveyance 112, and into a retention pit 124. The drilling fluid cools the drill bit 118 during operation and transports cuttings from the wellbore 104 into the retention pit 124.

The drilling system 100 may further include a bottom hole assembly (BHA) coupled to the conveyance 112 near the drill bit 118. The BHA may comprise various downhole measurement tools such as, but not limited to, measurement-while-drilling (MWD) and logging-while-drilling (LWD) tools, which may be configured to take downhole measurements of drilling conditions. The BHA may include a mud motor 126. The mud motor 126 may be operable to convert hydraulic energy of a fluid, such as drilling mud, into mechanical energy in the form of rotational speed and torque output, which may be harnessed for a variety of applications such as downhole drilling. The mud motor 126 may comprise a rotor disposed within a stator. A driveshaft may couple the rotor to the drill bit 118 disposed adjacent to the BHA. Drilling fluid or mud may be pumped under pressure between the rotor and stator, causing the rotor, as well as the drill bit 118 coupled to the rotor, to rotate relative to the stator. In general, the rotor may comprise a rotational speed proportional to the volumetric flow rate of pressurized fluid passing through the mud motor 126.

As the drill bit 118 extends the wellbore 104 through the formations 106, the BHA may continuously or intermittently transmit signals and receive back signals relating to a parameter of the formations 106, for example, impulse signals such as Wicker wavelet, Blackman pulse or its higher order time derivatives, as well as chirp signals, etc. The BHA may be communicably coupled to a telemetry module 128 used to transfer measurements and signals from the BHA to a surface receiver (not shown) and/or to receive commands from the surface receiver. The telemetry module 128 may encompass any known means of downhole communication including, but not limited to, a mud pulse telemetry system, an acoustic telemetry system, a wired communications system, a wireless communications system, or any combination thereof. In certain embodiments, some or all of the measurements taken at the BHA may also be stored within the BHA or the telemetry module 128 for later retrieval at the surface upon retracting the conveyance 112.

As illustrated, a controller 130 for controlling, processing, storing, and/or visualizing the measurements gathered by the BHA may be included in the drilling system 100. The controller 130 may be communicably coupled to the BHA by way of the conveyance 112. In one or more embodiments, the controller 130 may be disposed about any suitable location in the drilling system 100. In alternate embodiments, controller 130 may be located remotely from the system 100. The controller 130 may be directly or indirectly coupled to any one or more components of the drilling system 100.

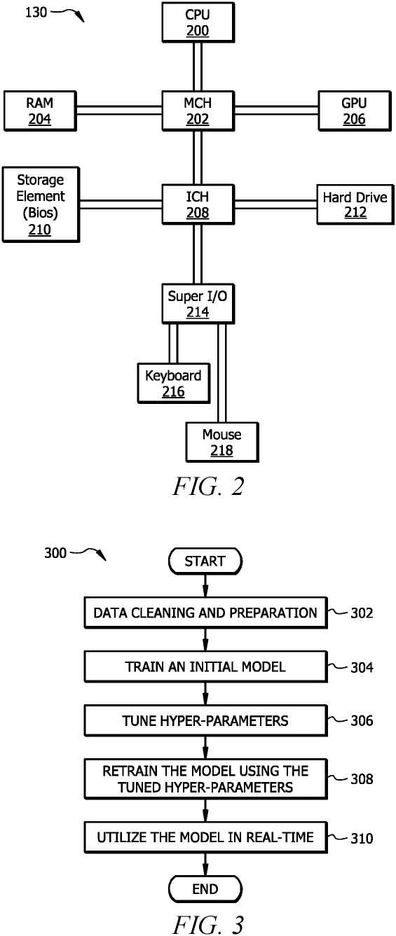

FIG. 2 is a diagram illustrating an example controller 130, according to aspects of the present disclosure. A processor or central processing unit (CPU) 200 of the controller 130 is communicatively coupled to a memory controller hub or north bridge 202. The processor 200 may include, for example a microprocessor, microcontroller, digital signal processor (DSP), application specific integrated circuit (ASIC), or any other digital or analog circuitry configured to interpret and/or execute program instructions and/or process data. Processor 200 may be configured to interpret and/or execute program instructions or other data retrieved and stored in any memory such as memory 204 or hard drive 212. Program instructions or other data may constitute portions of a software or application for carrying out one or more methods described herein. Memory 204 may include read-only memory (ROM), random access memory (RAM), solid state memory, or disk-based memory. Each memory module may include any system, device or apparatus configured to retain program instructions and/or data for a period of time (e.g., computer-readable non-transitory media). For example, instructions from a software or application may be retrieved and stored in memory 204 for execution by processor 200.

Modifications, additions, or omissions may be made to FIG. 2 without departing from the scope of the present disclosure. For example, FIG. 2 shows a particular configuration of components of controller 130. However, any suitable configurations of components may be used. For example, components of controller 130 may be implemented either as physical or logical components. Furthermore, in some embodiments, functionality associated with components of controller 130 may be implemented in special purpose circuits or components. In other embodiments, functionality associated with components of controller 130 may be implemented in configurable general-purpose circuit or components. For example, components of controller 130 may be implemented by configured computer program instructions.

Memory controller hub (MCH) 202 may include a memory controller for directing information to or from various system memory components within the controller 130, such as memory 204, storage element 210, and hard drive 212. The memory controller hub 202 may be coupled to memory 204 and a graphics processing unit (GPU) 206. Memory controller hub 202 may also be coupled to an I/O controller hub (ICH) or south bridge 208. I/O controller hub 208 is coupled to storage elements of the controller 130, including a storage element 210, which may comprise a flash ROM that includes a basic input/output system (BIOS) of the computer system. I/O controller hub 208 is also coupled to the hard drive 212 of the controller 130. I/O controller hub 208 may also be coupled to a Super I/O chip 214, which is itself coupled to several of the I/O ports of the computer system, including keyboard 216 and mouse 218.

In certain embodiments, the controller 130 may comprise at least a processor and a memory device coupled to the processor that contains a set of instructions that when executed cause the processor to perform certain actions. In any embodiment, the controller 130 may include a non-transitory computer readable medium that stores one or more instructions where the one or more instructions when executed cause the processor to perform certain actions. As used herein, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a computer terminal, a network storage device, or any other suitable device and may vary in size, shape, performance, functionality, and price. The controller 130 may include random access memory (RAM), one or more processing resources such as a central processing unit (CPU) or hardware or software control logic, read only memory (ROM), and/or other types of nonvolatile memory. Additional components of the controller 130 may include one or more disk drives, one or more network ports for communication with external devices as well as various input and output (I/O) devices, such as a keyboard, a mouse, and a video display. The controller 130 may also include one or more buses operable to transmit communications between the various hardware components.

FIG. 3 is a flowchart illustrating an example method 300 of operation with the drilling system 100 of FIG. 1. In embodiments, method 300 may be utilized by the controller 130 (referring to FIG. 1) and the mud motor 126 (referring to FIG. 1) to automatically determine a mud motor drilling mode. The method 300 may begin at step 302 where data or information from historical runs may be processed and statistical information may be extracted. In embodiments, the data or information may be stored in the memory 204 (referring to FIG. 2) of the controller 130 as historical run information 132 (referring to FIG. 1). The processor 202 (referring to FIG. 2) of the controller 130 may be operable to determine drilling measurements based on the historical run information 132. In embodiments, the drilling measurements may include revolutions per minute (RPM), tool-face (TF), torque, flowrate, weight on bit (WOB), rate of penetration (ROP), differential pressure (dSPP), and any combination thereof. In one or more embodiments, the historical run information 132 may be recorded at different frequencies and have different noise characteristics. As such, the controller 132 may be operable to implement numerous cleaning or filtering processes within step 302. While historical run information 132 may be considered in a depth domain in the following embodiments, a time domain may be used.

Within step 302, the processor 202 may filter the historical run information 132 to determine drilling measurements. Data comprising measurements, such as tool-face, may be designated with a rig activity such as “drilling”, “non-drilling”, “tripping-in”, or “tripping-out”, to indicate when the measurements were taken. Any suitable method to designate the data with a rig activity may be utilized. In certain embodiment, the tool-face measurements previously pulsed up to the surface may be corrupted. In this example, corrupted data may be processed out before the method 300 proceeds to further steps. Additionally, outliers may be detected and removed or filled. As data associated with drilling is of interest, the depth information associated with tool-face measurements should be monotonic. Any measurements comprising decreasing depths may be removed. In addition to actual measurements, statistical information such as mean, median, standard deviation (STD), mean absolute deviation (MAD), and the like, may be determined for use in indicating the mud motor drilling mode. In embodiments, additional data cleaning steps such as data syncing, outlier’s detection, rebuilding missing data, quality check, normalizing data, and the like may be applied. The method 300 may then proceed to step 304.

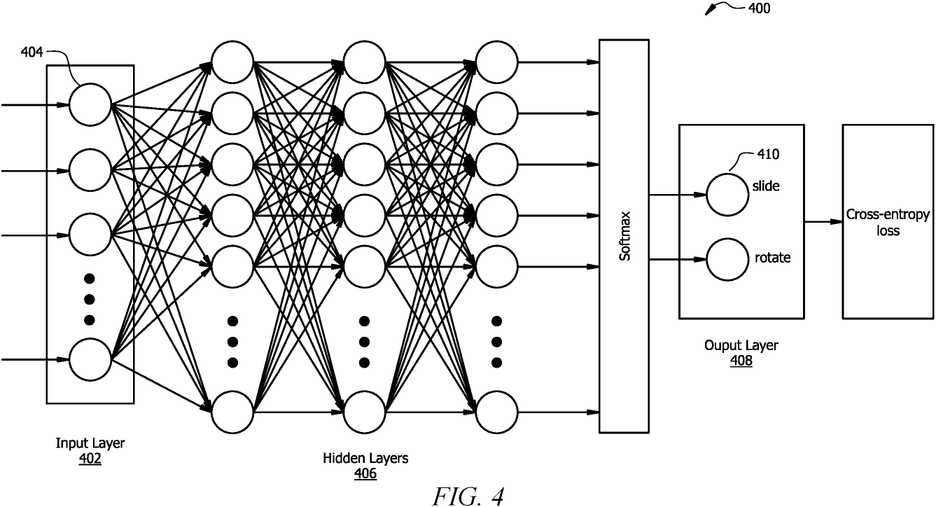

At step 304, the processor 202 of the controller 130 may train an initial model (for example, deep neural network model 400 in FIG. 4) with a machine learning method using the determined drilling measurements from step 302. In embodiments, the initial model may be selected from a group consisting of a deep neural network model, Random Forest, Decision Tree, K-nearest neighbors, Naive Bayes Classifier, and any combination thereof. In embodiments, the initial model may comprise one or more inputs selected from a group consisting of revolutions per minute, tool-face, torque, flowrate, weight on bit, rate of penetration, differential pressure, a derivative thereof, and any combination thereof. For each set of inputs or predictors (e.g., average RPM, standard deviation of RPM, standard deviation of TF, average WOB, and/or average torque), an operator may label an associated mud motor drilling mode obtained from a slide sheet as integer values, wherein the slide sheet is available at the end of each drilling operation. For example, the labels for the mud motor drilling mode may be selected from a group consisting of rotating, sliding, sliding without pipe rocking, sliding with pipe rocking, and any combination thereof. In embodiments, pipe rocking is a process used during slide drilling to reduce friction between the drill string and the wellbore. In embodiments, depending on the availability of the determined drilling measurements and how often prediction of a mud motor drilling mode is desired, a step size may be adjusted. During the length of the step size, there may be an assumption of the mud motor drilling mode being uniform or constant.

Processor 202 may be further operable to determine a performance evaluation metric for training the initial model. Depending on the objective, different evaluation metrics such as a confusion matrix (i.e., accuracy, precision, sensitivity, F1-score), gain and lift charts, Area Under the Curve (AUC), and the like, may be used to evaluate the performance of the model. In embodiments, the F1-score is the harmonic mean of a model’s precision and recall and may provide a way of combining precision and recall into a single metric that can be used to evaluate the performance of the model. Further in step 304, the determined drilling measurements, which may include all or a subset of samples from the historical runs, may be concatenated into a master dataset. The samples may be randomly selected and split into a training set, a validation set, and an optional testing set. The training set may be used to train the initial model by optimizing a cost function. When defining the cost function, a regularization term may be added to the cost function to prevent overfitting or an over-complicated model. The validation and testing sets may be used to evaluate the performance of the trained, initial model as well as to tune hyper-parameters in a later step (step 306).

Next, a machine learning method may be selected to train the initial model. For example, a deep neural network model with the size of a row vector L = (l₁, l₂,..., lₙ), where l₁ is the number of neurons in layer 1, and lₙ is the number of neurons in layer n, may be trained using a scaled conjugate gradient algorithm with cross entropy as the performance function. In this example, a softmax activation function, as shown in Equation 1, may be used in the last hidden layer to normalize the output of the deep neural network model to a probability distribution over predicted output classes (described further below). In other embodiments, other activation functions such as sigmoid, Rectified Linear Unit (ReLU) or leaking ReLU, may be selected.

$$s o f t m a x \left({z}_{j}\right) = \frac{{e}_{j}^{z}}{{\sum }_{k = 1}^{K} {e}_{k}^{z}} f o r j = 1 , … K$$

The cross-entropy loss of each sample may be calculated as shown in Equation 2.

$${L}_{C E} = - {\sum }_{K = 1}^{k} {y}_{k} log \left({\hat{y}}_{k}\right)$$

where K is the total number of classes; y is the actual label whose value is 1 or 0; and ŷ is the predicted class probability, whose value ranges from 0 to 1. Then, the cost function may be calculated as the sum of cross-entropy loss of all the samples in Equation 3.

$$C o s t = \frac{1}{m} {\sum }_{i = 1}^{m} {L}_{C E} \left({\hat{y}}_{i} , {y}_{i}\right)$$

The output of the trained initial model, which are the probabilities of each class, may then be converted to class labels. The class that has the highest probability is the predicted mud motor drilling mode (for example, 0.9 for rotating and 0.1 for sliding results in a designation for rotating). When training the initial model, different learning techniques and optimization algorithms may be employed to reduce computational costs and better performance. For example, in the case of above with a deep neural network model, pruning may be utilized to eliminate unnecessary values in weight tensors which results in a compressed deep neural network that runs faster while maintaining the same performance. Additionally, dropout may be used to regularize and help reducing interdependent learning amongst the neurons. The method 300 then proceeds to step 306.

At step 306, the processor 202 of the controller 130 may tune hyper-parameters. In one or more embodiments, the hyper-parameters may include the number of layers, number of neurons in each layer, learning rate, regularization parameter, and the like. The hyper-parameters may be tuned using the trained initial model and the inputs from the validation and testing sets from step 304 to address any over fitting or under fitting issues with the trained initial model. The method 300 then proceeds to step 308.

At step 308, the processor 202 of the controller 130 may re-train the trained initial model using the tuned hyper-parameters. In these embodiments, the processor 202 performs similar operations and functions as described in step 304 with the addition of using the tuned hyper-parameters. In one or more embodiments, more than one model may be trained given different sets of inputs or predictors. For example, there can be a model with only tool-face standard deviation as the input or predictor, a model with tool-face standard deviation and average RPM as the inputs or predictors, a model with RPM standard deviation and ROP average as the inputs or predictors. Each model may be trained using different machine learning methods that result in an optimal performance. These models may further be combined to improve the quality of the output. In one or more embodiments, the method 300 may proceed by selecting one of the one or more trained initial models for utilization in real-time based on available data. The method 300 then proceeds to step 310.

At step 310, the processor 202 of the controller 130 may utilize the re-trained initial model in real-time for a drilling operation to determine the mud motor drilling mode for the mud motor 126. For a given drilling operation, the data from the run may be cleaned and statistical information may be extracted in a similar manner as described in the step 302. Then, depending on the availability of the data, one or more model(s) may be selected to predict the mud motor drilling mode given the inputs from the data. In embodiments, a model with more predictors may provide a more accurate prediction than a model with limited predictors. A predicted mud motor drilling mode may be supplied to subsequent modules, such as a steering model calibration or a trajectory controller for making steering decisions and displayed in real time. In one or more embodiments, additional post-processing steps, such as removing slide/rotate data that are too short, may be applied to the predicted mud motor drilling mode in cases of transitioning or undesirable prediction. In embodiments, the controller 130 may transmit an instruction to a rig control system operable to control, among other components, a top drive (such as the rotary table 116) based, at least in part, on the determined mud motor drilling mode. The instruction may be sent to a closed-loop control algorithm, a directional drilling automated platform, and/or a rig control/operating system. Further, a transmission may then be sent to the mud motor 126 for actuation. In one or more embodiments, at the end of a drilling operation run, a slide sheet, which records all the mud motor drilling modes throughout the run may be produced. This data may be added to the master dataset as described in step 304 for re-training with additional information within the established system. The method 300 then proceeds to end.

FIG. 4 illustrates an example model 400 for use in method 300 (referring to FIG. 3). As illustrated, the model 400 may be a neural network model. In some embodiments, the neural network model may be a deep neural network model. Without limitations the model 400 may be a different model, such as Random Forest, Decision Tree, K-nearest neighbors, Naive Bayes Classifier, and any combination thereof. The model 400 may include an input layer 402 comprising one or more inputs 404. As previously described, the model 400 may comprise one or more inputs 404 selected from a group consisting of revolutions per minute, tool-face, torque, flowrate, weight on bit, rate of penetration, differential pressure, a derivative thereof, a statistical measurement thereof, and any combination thereof. The model 400 may comprise one or more hidden layers 406 between the input layer 402 and an output layer 408 comprising one or more probabilities 410 of a determined label for an associated mud motor drilling mode (for example, “sliding” or “rotating”). In one or more embodiments, the one or more inputs 404 may be provided to the one or more hidden layers 406 for use by an activation function. Each of the one or more inputs 404 may be used in a function for each neuron contained in each hidden layer 406. The function may produce a value that becomes an input for a neuron for a subsequent hidden layer 406. The neurons in the output layer 408 may determine a final value from each received value from a prior layer. The illustrated connections between layers may be weighted. The final value is the prediction for that input 404. During operation, the controller 130 (referring to FIG. 1) may determine that the predicted mud motor drilling mode is the one of the one or more probabilities 410 comprising the highest value.

To facilitate a better understanding of the present disclosure, the following examples of certain aspects of certain embodiments are given. The following examples are not the only examples that could be given according to the present disclosure and are not intended to limit the scope of the disclosure or claims.

### Example 1

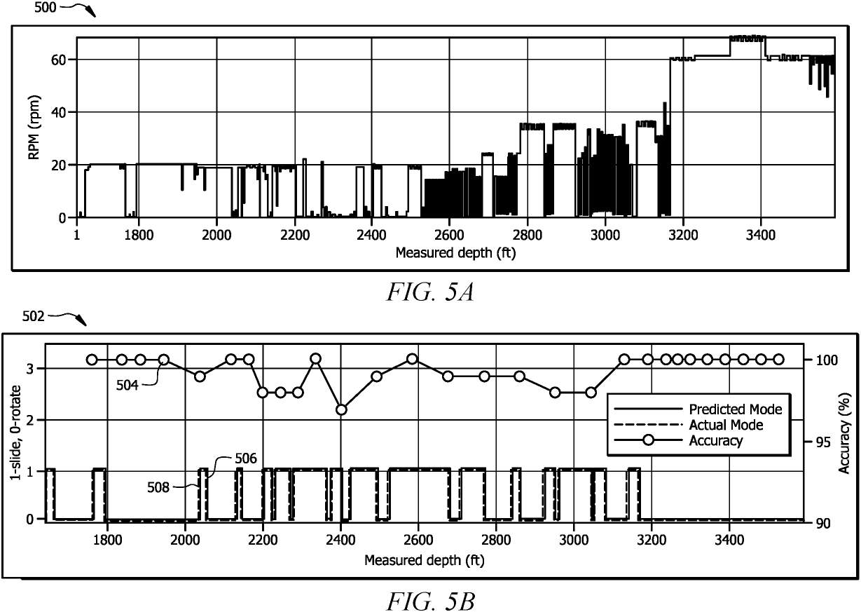

FIG. 5A illustrates a graph 500 depicting revolutions per minute (RPM) for historical run information 132 (referring to FIG. 1). Within graph 500, RPM is monitored as a function of depth. Graph 500 illustrates when the mud motor 126 (referring to FIG. 1) is in a sliding or rotating mode. For example, the graph 500 shows the mud motor 126 rotating at lower RPMs with intermittent sliding at 0 RPM up until about 2500 feet. At about 2500 feet, the mud motor 126 is shown to be in a sliding with pipe rocking mode (designated at the solid shading), wherein the pipe rocking RPM increases to about 35-38 RPM. Controller 130 (referring to FIG. 1) may be operable to process the data provided in graph 500 to determine a mud motor drilling operation.

### Example 2

FIG. 5B illustrates a graph 502 depicting mud motor drilling mode as a function of depth. Within graph 502, accuracy of a predicted and an actual mud motor drilling mode is illustrated and superimposed against the mud motor drilling mode as a function of depth. Graph 502 depicts accuracy 504, a predicted mode 506, and an actual mode 508. For example, the actual mode 508 may be the real mud motor drilling mode reflected in stored historical run information 132 (referring to FIG. 1). The predicted mode 506 may be the mud motor drilling mode produced from the model 400 (referring to FIG. 4) by method 300 (referring to FIG. 3). Accuracy 504 may depict the difference between the predicted mode 506 and the actual mode 508 as a function of depth.

An embodiment of the present disclosure is a method for identifying a mud motor drilling mode, comprising: accessing historical run information stored in a memory of a controller; determining drilling measurements based on the historical run information; training at least one initial model with a machine learning method using the determined drilling measurements, wherein the at least one initial model comprises one or more inputs selected from a group consisting of revolutions per minute, tool-face, torque, flowrate, weight on bit, rate of penetration, differential pressure, a derivative thereof, and any combination thereof; and utilizing the trained at least one initial model to determine the mud motor drilling mode for a mud motor.

In one or more embodiments described in the preceding paragraph, further comprising processing the historical run information to remove ancillary data and determine statistical information associated with the determined drilling measurements. In one or more embodiments described above, further comprising: determining hyper-parameters of the at least one initial model; and re-training the at least one initial model using the determined hyper-parameters. In one or more embodiments described above, wherein the at least one initial model is selected from a group consisting of a neural network model, Random Forest, Decision Tree, K-nearest neighbors, Naive Bayes Classifier, and any combination thereof. In one or more embodiments described above, further comprising using a scaled conjugate gradient algorithm with cross entropy as a performance function for evaluating a performance of the at least one initial model, wherein the cost function is calculated as the sum of cross-entropy loss. In one or more embodiments described above, wherein the cost function comprises a regularization term to prevent overfitting or an over-complicated model. In one or more embodiments described above, further comprising actuating the mud motor or a rotary table operable to provide rotation to a conveyance based, at least in part, on the determined mud motor drilling mode, wherein the mud motor is coupled to the conveyance. In one or more embodiments described above, wherein the mud motor drilling mode is determined as one selected from a group consisting of rotating, sliding, sliding without pipe rocking, sliding with pipe rocking, a derivative thereof, and any combination thereof. In one or more embodiments described above, further comprising selecting one of one or more trained initial models for utilization in real-time.

Another embodiment of the present disclosure is a non-transitory computer-readable medium comprising instructions that are configured, when executed by a processor, to: access historical run information stored in a memory of a controller communicatively coupled to the processor; determine drilling measurements based on the historical run information; train at least one initial model with a machine learning method using the determined drilling measurements, wherein the at least one initial model comprises one or more inputs selected from a group consisting of revolutions per minute, tool-face, torque, flowrate, weight on bit, rate of penetration, differential pressure, a derivative thereof, and any combination thereof; and utilize the trained at least one initial model to determine the mud motor drilling mode for a mud motor.

In one or more embodiments described in the preceding paragraph, wherein the instructions are further configured to process the historical run information to remove ancillary data and determine statistical information associated with the determined drilling measurements. In one or more embodiments described above, wherein the instructions are further configured to determine hyper-parameters of the at least one initial model; and re-train the at least one initial model using the determined hyper-parameters. In one or more embodiments described above, wherein the initial model is selected from a group consisting of a neural network model, Random Forest, Decision Tree, K-nearest neighbors, Naive Bayes Classifier, and any combination thereof. In one or more embodiments described above, wherein the instructions are further configured to use a scaled conjugate gradient algorithm with cross entropy as a performance function for evaluating a performance of the at least one initial model, wherein the cost function is calculated as the sum of cross-entropy loss. In one or more embodiments described above, wherein the cost function comprises a regularization term to prevent overfilling or an over-complicated model. In one or more embodiments described above, wherein the instructions are further configured to transmit an instruction to actuate the mud motor or a rotary table operable to provide rotation to a conveyance based, at least in part, on the determined mud motor drilling mode, wherein the mud motor is coupled to the conveyance. In one or more embodiments described above, wherein the mud motor drilling mode is determined as one selected from a group consisting of rotating, sliding, sliding without pipe rocking, sliding with pipe rocking, a derivative thereof, and any combination thereof. In one or more embodiments described above, wherein the instructions are further configured to select one of one or more trained initial models for utilization in real-time.

A further embodiment of the present disclosure is a system for determining a mud motor drilling mode, comprising: a controller comprising: a memory operable to store historical run information; and a processor operable to: access the historical run information stored in the memory; determine drilling measurements based on the historical run information; train at least one initial model with a machine learning method using the determined drilling measurements, wherein the at least one initial model comprises one or more inputs selected from a group consisting of revolutions per minute, tool-face, torque, flowrate, weight on bit, rate of penetration, differential pressure, a derivative thereof, and any combination thereof; and utilize the trained at least one initial model to determine the mud motor drilling mode for a mud motor; and the mud motor disposed in a bottom hole assembly on a conveyance communicatively coupled to the controller. In one or more embodiments previously described, wherein the processor is further operable to transmit an instruction to actuate the mud motor or a rotary table operable to provide rotation to the conveyance based, at least in part, on the determined mud motor drilling mode, wherein the mud motor is coupled to the conveyance.

Unless indicated to the contrary, the numerical parameters set forth in the specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The disclosure illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method for identifying a mud motor drilling mode, comprising:
accessing historical run information stored in a memory of a controller;
determining drilling measurements based on the historical run information;
training at least one initial model with a machine learning method using the determined drilling measurements, wherein the at least one initial model comprises one or more inputs selected from a group consisting of revolutions per minute, tool-face, torque, flowrate, weight on bit, rate of penetration, differential pressure, a derivative thereof, and any combination thereof; and
utilizing the trained at least one initial model to determine the mud motor drilling mode for a mud motor.

2. The method of claim 1, further comprising processing the historical run information to remove ancillary data and determine statistical information associated with the determined drilling measurements.

3. The method of claim 1, further comprising:
determining hyper-parameters of the at least one initial model; and
re-training the at least one initial model using the determined hyper-parameters.

4. The method of claim 1, wherein the at least one initial model is selected from a group consisting of a neural network model, Random Forest, Decision Tree, K-nearest neighbors, Naive Bayes Classifier, and any combination thereof.

5. The method of claim 1, further comprising using a scaled conjugate gradient algorithm with cross entropy as a performance function for evaluating a performance of the at least one initial model, wherein the cost function is calculated as the sum of cross-entropy loss.

6. The method of claim 5, wherein the cost function comprises a regularization term to prevent overfitting or an over-complicated model.

7. The method of claim 1, further comprising actuating the mud motor or a rotary table operable to provide rotation to a conveyance based, at least in part, on the determined mud motor drilling mode, wherein the mud motor is coupled to the conveyance.

8. The method of claim 1, wherein the mud motor drilling mode is determined as one selected from a group consisting of rotating, sliding, sliding without pipe rocking, sliding with pipe rocking, a derivative thereof, and any combination thereof.

9. The method of claim 1, further comprising selecting one of one or more trained initial models for utilization in real-time.

10. A non-transitory computer-readable medium comprising instructions that are configured, when executed by a processor, to:
access historical run information stored in a memory of a controller communicatively coupled to the processor;
determine drilling measurements based on the historical run information;
train at least one initial model with a machine learning method using the determined drilling measurements, wherein the at least one initial model comprises one or more inputs selected from a group consisting of revolutions per minute, tool-face, torque, flowrate, weight on bit, rate of penetration, differential pressure, a derivative thereof, and any combination thereof; and
utilize the trained at least one initial model to determine the mud motor drilling mode for a mud motor.

11. The non-transitory computer-readable medium of claim 10, wherein the instructions are further configured to:
process the historical run information to remove ancillary data and determine statistical information associated with the determined drilling measurements.

12. The non-transitory computer-readable medium of claim 10, wherein the instructions are further configured to:
determine hyper-parameters of the at least one initial model; and
re-train the at least one initial model using the determined hyper-parameters.

13. The non-transitory computer-readable medium of claim 10, wherein the initial model is selected from a group consisting of a neural network model, Random Forest, Decision Tree, K-nearest neighbors, Naïve Bayes Classifier, and any combination thereof.

14. The non-transitory computer-readable medium of claim 10, wherein the instructions are further configured to:
use a scaled conjugate gradient algorithm with cross entropy as a performance function for evaluating a performance of the at least one initial model, wherein the cost function is calculated as the sum of cross-entropy loss.

15. The non-transitory computer-readable medium of claim 14, wherein the cost function comprises a regularization term to prevent overfitting or an over-complicated model.

16. The non-transitory computer-readable medium of claim 10, wherein the instructions are further configured to:
transmit an instruction to actuate the mud motor or a rotary table operable to provide rotation to a conveyance based, at least in part, on the determined mud motor drilling mode, wherein the mud motor is coupled to the conveyance.

17. The non-transitory computer-readable medium of claim 10, wherein the mud motor drilling mode is determined as one selected from a group consisting of rotating, sliding, sliding without pipe rocking, sliding with pipe rocking, a derivative thereof, and any combination thereof.

18. The non-transitory computer-readable medium of claim 10, wherein the instructions are further configured to:
select one of one or more trained initial models for utilization in real-time.

19. A system for determining a mud motor drilling mode, comprising:
a controller comprising:
a memory operable to store historical run information; and
a processor operable to:
access the historical run information stored in the memory;
determine drilling measurements based on the historical run information;
train at least one initial model with a machine learning method using the determined drilling measurements, wherein the at least one initial model comprises one or more inputs selected from a group consisting of revolutions per minute, tool-face, torque, flowrate, weight on bit, rate of penetration, differential pressure, a derivative thereof, and any combination thereof; and
utilize the trained at least one initial model to determine the mud motor drilling mode for a mud motor; and
the mud motor disposed in a bottom hole assembly on a conveyance communicatively coupled to the controller.

20. The system of claim 19, wherein the processor is further operable to transmit an instruction to actuate the mud motor or a rotary table operable to provide rotation to the conveyance based, at least in part, on the determined mud motor drilling mode, wherein the mud motor is coupled to the conveyance.
